(19) United States
(12) Patent Application Publication
(10) Pub. No.: US 2008/0138558 A1
(43) Pub. Date: Jun. 12, 2008

(54) Peelable multilayer surface protecting film and articles thereof

(76) Inventors: Sassan Hojabr, Kingston (CA); Scott B. Marks, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/635,151

(22) Filed: Dec. 7, 2006

(51) Int. Cl. B32B 33/00

(52) U.S. Cl. 428/42.2

(57) ABSTRACT

Disclosed is a peelable surface protective film comprising a structure layer and an adhesive layer comprising a blend of at least one ethylene/vinyl acetate copolymer or at least one ethylene/alkyl acrylate copolymer, an anhydride modified ethylene copolymer and tackifier. The film can be used to protect the surface of plates or panels used in construction materials, vehicles, and the like, particularly during transportation, storage and/or assembly. Also disclosed are articles comprising the film and a process for using the film.

### FIELD OF THE INVENTION

This invention relates to multilayer structures comprising a structure layer and an adhesive layer that are useful as a peelable surface protecting film. The film can be used to protect the surface of plates or panels used in construction materials, vehicles, and the like, particularly during transportation, storage and/or assembly.

### BACKGROUND OF THE INVENTION

Metal plates such as color-coated steel plates, stainless steel plates, and aluminum plates are used in construction materials such as building panels, vehicles, appliances, etc. These metal plates may also be subjected to various treatments such as surface polishing, texturizing, coating, painting and anticorrosion treatments.

A protective film or “masking film” may be used to prevent damage, contamination and/or corrosion of the surface of the plates or panels. The film is adhered to a decorative or finished panel surface to protect the panel surface during fabrication, transportation, and/or installation processes. Such masking films need to be readily applied to the surface with sufficient adhesion to remain attached until they are removed. Typically, the film is peeled from the surface to be protected at the final installation point either before or after the installation is completed. Therefore, it is desirable to peel the masking films without excessive force. Furthermore, it is desirable to do so without leaving any residue on the surface that would require extra cleaning at additional cost.

Peel strength may be impacted by the conditions to which the panels are exposed, such as temperature, humidity, rain and other weather phenomena, and the length of time they are adhered to the surface. Peel strength can either “age-up” (increase) or “age-down” (decrease) between the time of application and removal of the film. Although some deviations from the initial “green peel strength” can be tolerated, significant age-up or age-down could result in undesired properties. Therefore, it is desirable that the peel strength remains stable over extended periods of time and a variety of weather exposures.

Previous surface protecting films included films made from materials such as polyvinyl chloride, ethylene-vinyl acetate copolymers, and polyolefins. However, in these films, appropriate adhesion was difficult to obtain, and the adhesive strength changed significantly over time. For example, if the adhesive strength was lowered, the films peeled off too readily during handling of the metal plates. If the adhesive strength was too strong, removal of the film was difficult, or the metal surfaces after removal were contaminated with adhesive. Furthermore, the adhesive strength of the films often caused the metal plates to stick to each other when they were rolled or stacked, reducing their utility.

Some currently used adhesive films have a pressure sensitive adhesive (PSA) coated onto a polymer backing such as a polyethylene backing. A drawback of these films is adhesive transfer from the film to the panel surface, necessitating cleaning of the panels after removal of the film. Also, PSA-coated films are relatively expensive due to multiple processing steps.

Japanese Patent JP3637940B2 describes peelable protective films having a thermosetting adhesive layer comprising an organic peroxide and a copolymer of ethylene, vinyl acetate and maleic acid or maleic anhydride.

Japanese Patent JP62001668B describes peelable protective films having an adhesive layer composed of an ethylene vinyl acetate copolymer, a tackifier and a polypropylene resin modified with an unsaturated carboxylic acid laminated to a bulk layer comprising a thermoplastic resin. The protective films are applied at temperatures of 60 to 120° C., for example at 100° C.

It is desirable that protective films be removed with minimal effort and with no residue remaining. A coextruded multilayer thermoplastic film that may be applied to the building panel in a continuous thermal lamination process, particularly at temperatures from 40 to 60° C., is also desirable to improve processing efficiency and reduce costs.

### SUMMARY OF THE INVENTION

This invention relates to a peelable surface protecting film comprising or consisting essentially of:

(1) a thermoplastic resin structure layer; and

(2) a layer of a heat activated adhesive composition comprising

(a) a copolymer comprising copolymerized residues of ethylene and copolymerized residues of vinyl acetate or copolymerized residues of an alkyl acrylate, the alkyl group having from 1 to 4 carbon atoms;

(b) a copolymer comprising copolymerized residues of ethylene, copolymerized residues of vinyl acetate or copolymerized residues of an alkyl acrylate, the alkyl group having from 1 to 4 carbon atoms, and copolymerized residues of an unsaturated dicarboxylic anhydride moiety; and

(c) from about 4 to about 35 weight % of tackifier;

wherein the combination of (a) and (b) is from about 65 to about 96 weight % of the total of (a), (b) and (c), the total C(═O)O moieties of (a) and (b) are present in from about 7 to about 15 weight % of the combination of (a) and (b), and the anhydride moiety is present in from about 0.03 to about 2 weight % of the total of (a), (b) and (c).

A particular embodiment of the peelable multilayer surface protecting film is a coextruded film comprising (1) and (2).

Another embodiment is an article comprising the peelable surface protecting film comprising (1) and (2), and further comprising a substrate, wherein the adhesive layer is peelably adhered to the substrate. In this embodiment, the substrate may be metal, plastic or resin material, wood, wood composite, masonite, hardboard, medium density fiberboard, fiber-reinforced plastics, cementboard or glass, optionally having at least one substrate surface-treatment layer selected from the group consisting of surface polishing, texturizing, coating, painting, laminating of an image and anticorrosion treatment intervening between the adhesive layer and the substrate.

This invention also relates to the use of the peelable multilayer surface protecting film to protect the surface of a plate or panel such as color-coated steel plates, stainless steel plates, and aluminum plates, wherein the adhesive layer is peelably adhered to the plate. Accordingly, an embodiment is an article wherein the film described above wherein the adhesive layer is peelably adhered to a plate; for example, wherein the plate is selected from the group consisting of color-coated steel plates, stainless steel plates and aluminum plates.

Another embodiment is an article wherein one face of an adhesive layer is peelably adhered to a substrate comprising metal, plastic or resin material, wood, wood composite, masonite, hardboard, medium density fiberboard, fiber-reinforced plastics, cementboard or glass, either directly or through at least one intervening substrate surface-treatment layer; and the other face of the adhesive layer is irreversibly adhered to a structure layer comprising a thermoplastic resin; wherein the adhesive layer comprises

(a) a copolymer of ethylene and a comonomer selected from the group consisting of vinyl acetate and an alkyl acrylate, the alkyl group having from 1 to 4 carbon atoms;

(b) a copolymer of ethylene and a comonomer selected from the group consisting of vinyl acetate and an alkyl acrylate, the alkyl group having from 1 to 4 carbon atoms, grafted with maleic anhydride; and

(c) from 4 to 35 weight % of tackifier;

wherein the combination of (a) and (b) is from 65 to 96 weight % of the total of (a), (b) and (c), the total C(═O)O moieties of (a) and (b) are present in from 7 to 15 weight % of the combination of (a) and (b), and the maleic anhydride moiety is present in from 0.03 to 2 weight % of the total of (a), (b) and (c).

The substrate surface-treatment layer may be selected from the group consisting of surface polishing, texturizing, coating, painting, laminating of an image and anticorrosion treatment.

Such articles as described above include as the substrate a building panel or a body panel of a vehicle, appliance, furniture, cabinet, or glazing.

This invention also relates to a process comprising providing an article as described above and peeling the surface protecting film, or the adhesive layer and the structure layer, from the substrate.

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. In general, an amount, size, formulation, parameter or other quantity or characteristic is “about” or “approximate” whether or not expressly stated to be such.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” is employed to describe elements and components of the invention. This is done merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting.

In describing and/or claiming this invention, the term “copolymer” is used to refer to polymers containing copolymerized residues of two or more polymerizable moieties (that is, derived from, or prepared from, two or more comonomers). The use of the term “terpolymer” and/or “termonomer” means that the copolymer has at least three different comonomers. The term “(meth)acrylic acid” refers to methacrylic acid and/or acrylic acid, inclusively.

The term “plate” means an article having two major opposed surfaces having relatively large areas and a relatively thin cross-section.

The term “C(═O)O” as used herein is line notation for a carboxyl group, that is, a moiety having a carbon atom with a double bond to one oxygen atom, a single bond to a second oxygen atom and a single bond to either a hydrogen atom or another carbon atom, preferably to another carbon atom. Another equivalent notation for the carboxyl group is “CO₂”.

Thermoplastic compositions are polymeric materials that can flow when heated under pressure. Melt index (MI) is the mass rate of flow of a polymer through a specified capillary under controlled conditions of temperature and pressure. Melt indices reported herein are determined according to ASTM 1238 at 190° C. using a 2160 g weight, with values of MI reported in grams/10 minutes.

Thermally activated or heat activated adhesive compositions soften when heat is applied, adhere to a substrate and then harden, retaining adhesion. Unlike pressure-sensitive adhesives that remain tacky at ambient temperatures, thermally activated adhesives are not tacky unless heated. Thermally activated adhesive compositions as described herein and films comprising the compositions can be applied at relatively low temperatures, from 40 to 60° C. and preferably from 50 to 60° C. The films are useful as low-cost, peelable protective films that can be removed from the substrate without leaving an adhesive residue.

### Structure Layer

There is no particular limitation in the thermoplastic resin used in the structure layers in the films and articles, provided the structure layers have sufficient adhesion to the adhesive layer so that the film, including the adhesive layer, can be peeled cleanly from the surface of the panel. The structure layer can comprise one or more layers of thermoplastic resins. The structure layer(s) provide bulk to the film and serve as the protective portion of the film. Accordingly, the structure layer should be of sufficient strength and/or thickness to resist puncture and abrasion so that the finish surface of a panel is protected from damage. In normal use the protective films could be exposed to outdoor conditions for about one to two months. Accordingly, the structure layer optionally contains an UV stabilizer component, for example carbon black, to protect the structure against damage from UV rays. Resins useful in the structure layer include low-density, intermediate-density, or high-density polyethylene homopolymers or copolymers, polypropylene homopolymers or copolymers, polyester, polyamide, polyvinyl chloride, and polycarbonate, etc. or mixtures thereof, and optionally an ultraviolet stabilizer. A polyethylene or polypropylene resin is preferable, particularly polyethylene such as linear low density polyethylene (LLDPE) or a mixture of low density polyethylene and linear low density polyethylene.

Polyethylenes (PE) can be prepared by a variety of methods, including well-known Ziegler-Natta catalyst polymerization (see for example U.S. Pat. Nos. 3,645,992 and 4,076,698), metallocene catalyst polymerization (see for example U.S. Pat. Nos. 5,198,401 and 5,405,922) and by free radical polymerization. Polyethylene polymers can include linear polyethylenes such as high-density polyethylene (HDPE), linear low-density polyethylene (LLDPE), very low or ultralow density polyethylenes (VLDPE or ULDPE) and branched polyethylenes such as low-density polyethylene (LDPE). The densities of suitable polyethylenes range from 0.865 g/cc to 0.970 g/cc. Linear polyethylenes can incorporate alpha-olefin comonomers such as butene, hexene or octene to decrease their density within the density range so described (that is, polyethylene copolymers, wherein ethylene is the major portion). The term “polyethylene” when used herein is used generically to refer to any or all of the polymers comprising ethylene described above.

Polypropylene (PP) polymers include homopolymers, random copolymers, block copolymers and terpolymers of propylene. Copolymers of propylene include copolymers of propylene (as the major portion) with other olefins such as ethylene, 1-butene, 2-butene and the various pentene isomers, etc. and preferably copolymers of propylene with ethylene. Terpolymers of propylene include copolymers of propylene with ethylene and one other olefin. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymers of propylene and ethylene. The polypropylene may be modified with small amounts of other polymers to improve its impact resistance. The term “polypropylene” when used herein is used generically to refer to any or all of the polymers comprising propylene described above.

Polypropylene homopolymers or random copolymers can be manufactured by any known process. For example, polypropylene polymers can be prepared in the presence of Ziegler-Natta catalyst systems, based on organometallic compounds and on solids containing titanium trichloride.

Block copolymers can be manufactured similarly, except that propylene is generally first polymerized by itself in a first stage and propylene and additional comonomers such as ethylene are then polymerized, in a second stage, in the presence of the polymer obtained during the first. Each of these stages can be carried out, for example, in suspension in a hydrocarbon diluent, in suspension in liquid propylene, or else in gaseous phase, continuously or noncontinuously, in the same reactor or in separate reactors.

Polyester resins include polymers derived from condensation of diols and diacids (or derivatives thereof). Of note is a polyester comprising an aromatic dicarboxylic acid as the main acid component. Examples include polyethylene terephthalate, polypropylene terephthalate, polytetramethylene terephthalate (polybutylene terephthalate), polycyclohexane-dimethylene terephthalate and polyethylene-2,6-naphthalene dicarboxylate. These polyesters may also be copolymers copolymerized with either another alcohol and/or another dicarboxylic acid as additional components. Part of the dicarboxylic acid moiety thereof may be substituted by isophthalic acid, 2,6-naphthalenedicarboxylic acid, 1,4-cyclohexanedicarboxylic acid, adipic acid, sebacic acid, dimer acid, and isophthalic acid containing a metal salt of sulfonic acid as a substituent, such as 5-sodium sulfoisophthalate, for example. Part of the glycol moiety thereof may be substituted by diethylene glycol, neopentyl glycol, 1,4-cyclohexane diol, 1,4-cyclohexanedimethanol, polyalkylene glycol, 1,2 propanediol, 1,3-propanediol (trimethylene glycol) and 1,4-butanediol, for example. Use of a small amount of a chain-branching agent such as pentaerythritol, trimethylol propane, trimellitic acid, trimesic acid, or boric acid is also contemplated. Mixtures of two or more of these polyesters also may be used. The term “polyester” when used herein is used generically to refer to any or all of the polymers described above. The polyester preferably has polyethylene terephthalate (PET), polypropylene terephthalate (PPT) and/or polybutylene terephthalate (PBT) as main components thereof, and particularly preferred polyester comprises polyethylene terephthalate as a single main component.

Polyamides (PA), also known as “nylons” suitable for use in the structure layer are prepared from lactams or amino acids (e.g. nylon 6 or nylon 11), or prepared from condensation of diamines such as hexamethylene diamine with dibasic acids such as succinic, adipic, or sebacic acid. Copolymers and terpolymers of these polyamides are also included. The polyamide can include at least one member selected from the group consisting of nylon 6, nylon 9, nylon 10, nylon 11, nylon 12, nylon 6,6, nylon 6,10, nylon 6,12, nylon 61, nylon 6T, nylon 6,9, nylon 12,12, copolymers thereof and blends of amorphous and semicrystalline polyamides. Preferred polyamides are polyepsiloncaprolactam (nylon 6), polyhexamethylene adipamide (nylon 6,6), and most preferred is nylon 6.

The compositions used for the structure layer(s) can include optional additives as described in greater detail below. Optional additives of note include pigments such as titanium dioxide and carbon black that provide opacity and/or UV stabilization to the protective film. Preferred are films wherein the structure layer comprises low density polyethylene or a mixture of low density polyethylene and linear low density polyethylene, and optionally an ultraviolet stabilizer.

The structure layer(s) optionally may be provided with elements such as printing, coloring, embossing or texturing. Embodiments of these elements may include alphanumeric text, logos, pictures and the like to provide information for the consumer and/or a pleasing appearance to the protective film. These elements may be provided to the structure layers either before or after combining with the adhesive layer to form the multilayer structure.

### The Adhesive Layer

The components of the adhesive layer in the film and articles are selected to provide a level of adhesion for the protective film that allows the film to be removed from the substrate with minimal effort and with no residue remaining.

Peel strength is the amount of force required to remove to a film from a substrate. When peeling the film from the substrate under stress at various angles of peel and speeds, it is important that the adhesion between the film and the substrate be interfacial. Interfacial adhesions are designed to fail at the interface of the adhesive surface and the substrate (i.e., the sealant layer peels cleanly away from the substrate layer). Adhesives that do not peel cleanly can contaminate the surface of the substrate with fragments of the adhesive, and possibly of the film itself. Interfacial peelable seals are desirable to prevent such contamination. In most cases peel strength is determined by temperature, pressure and dwell time. For the films described herein, the adhesives are designed to adhere strongly to the structure layer yet provide interfacial adhesion to the substrate. The adhesive is also thermally activated, and the composition is designed to be suitable for application to the substrate at relatively low temperatures, from 40 to 60° C. and preferably from 50 to 60° C.

The peel strength of the adhesive should be sufficient to withstand handling, further processing, transportation and installation, but should be low enough such that the films can be removed from the substrate by hand with relative ease. Preferably, the peel strength is from about 80 to about 400 g/inch, more preferably from about 100 to about 250 g/inch. A typical PSA currently used has a peel strength value of 126 g/inch.

As used herein, the term “peelably adhered” means that there is an interfacial peelable seal between the adhesive layer and the substrate, such that the film can be peeled cleanly from the substrate by hand.

While it is necessary for the adhesive to be peelable from the substrate, the adhesive composition must also be strongly or irreversibly adhered to the structure layer so that the film maintains structural integrity throughout its use in protecting the substrate and when the film is peeled from the substrate. As used herein, the term “irreversibly adhered” means that adjacent layers cannot be separated by hand and the strength of the seal between the layers is such that the layers cannot be separated without damage to one or both of the layers. Preferably, the peel strength between the adhesive layer and the structure layer(s) is greater than about 1000 g/inch, more preferably greater than about 2000 g/inch.

In order to provide appropriate levels of adhesion, the adhesive composition is prepared so that the overall polarity falls within a desirable range. The polarity is dependent on the amount of polar comonomers present in the composition. Vinyl acetate and alkyl acrylate comonomers contain C(═O)O moieties that chiefly provide the polar component to the composition. As noted above, the total C(═O)O moieties are present in from about 7 to about 15 weight % of the combination of the ethylene copolymers in the composition.

Individual components of the adhesive composition are described more fully below.

### Ethylene/Vinyl Acetate Copolymers

The adhesive layer composition may have at least one ethylene/vinyl acetate copolymer (an EVA copolymer). Ethylene/vinyl acetate dipolymers includes copolymers derived from the copolymerization of ethylene and vinyl acetate. Ethylene/vinyl acetate terpolymers include copolymers derived from the copolymerization of ethylene, vinyl acetate and an additional comonomer.

The relative amount of the vinyl acetate comonomer incorporated into EVA copolymers can, in principle, vary broadly from about 7 weight percent up to as high as 45 weight percent of the total copolymer or even higher. The relative amount of the vinyl acetate present can be viewed as establishing to what degree the resulting copolymer is to be viewed as a polar polymeric constituent in the blended composition as measured by the C(═O)O moieties present. Of note are EVA copolymers having from about 15 to about 40 weight %, especially from 15 to 30 weight % of vinyl acetate. For example, the amount of vinyl acetate comonomer can be from 18 to 28 weight % of the copolymer.

The EVA copolymers preferably have a melting range below 90° C., below 85° C. or below 80° C. Melting ranges may be related to vinyl acetate content. For example, EVA copolymers melting below 90° C. may have VA content above 15 weight %, below 85° C. may have VA content above 18 weight %, and below 80° C. may have VA content above 23 weight %.

The EVA copolymers preferably have a melt index, measured in accordance with ASTM D 1238 at 190° C., ranging from 1, preferably 2 or 3, to 30 g/10 minutes, and especially from 2, preferably 3, to 15 g/10 minutes.

Ethylene/vinyl acetate copolymers suitable for use include those available from E. I. du Pont de Nemours and Company, Wilmington, Del. (DuPont).

When combined with other components of the adhesive composition, such as an anhydride-modified ethylene/vinyl acetate copolymer, the total vinyl acetate provides an amount of C(═O)O moieties. The weight % of C(═O)O moieties present in (a) and (b) can be correlated to the amount of copolymerized residues of vinyl acetate present. For example, 7, 8, 9 or 15 weight % of C(═O)O moieties correspond to about 12.5, 14.3, 16 or 27 weight % of copolymerized residues of vinyl acetate respectively.

A mixture of two or more different EVA copolymers can be used in the compositions in place of a single copolymer as long as they provide for comonomer content (in particular the C(═O)O weight % of the combination of (a) and (b)) consistent with the ranges indicated above. Particularly useful properties may be obtained when two or more properly selected EVA copolymers are used.

### Ethylene/Alkyl Acrylate Copolymers

The adhesive layer composition may have at least one ethylene/alky acrylate copolymer. The term “ethylene/alkyl acrylate copolymers” includes copolymers derived from copolymerization of ethylene and alkyl acrylates wherein the alkyl moiety contains from one to four carbon atoms. Examples of alkyl acrylates include methyl acrylate, ethyl acrylate and butyl acrylate. “Ethylene/methyl acrylate” (EMA) means a copolymer prepared from ethylene and methyl acrylate. “Ethylene/ethyl acrylate” (EEA) means a copolymer prepared from ethylene and ethyl acrylate. “Ethylene/butyl acrylate” (EBA) means a copolymer prepared from ethylene and butyl acrylate. Of note are ethylene/butyl acrylate copolymers prepared from i-butyl acrylate comonomers (EiBA) and ethylene/butyl acrylate copolymers prepared from n-butyl acrylate comonomers (EnBA).

The relative amount of the alkyl acrylate comonomer incorporated into the ethylene/alkyl acrylate copolymer can, in principle, vary broadly from a few weight percent up to as high as 40 weight percent of the total copolymer or even higher. Similarly, the choice of the alkyl group can, again in principle, vary from a simple methyl group up to a four-carbon atom alkyl group with or without branching. The relative amount and choice of the alkyl acrylate comonomer can be viewed as establishing how and to what degree the resulting ethylene copolymer is to be viewed as a polar polymeric constituent in the adhesive composition, as measured by the C(═O)O moieties present.

For example, copolymerized residues of methyl acrylate may be present in from 8 to 25 weight % of the copolymer; copolymerized residues of butyl acrylate may be present in from 10 to 35 weight % of the copolymer.

The ethylene/alkyl acrylate copolymers may have a melting range below 95° C., alternatively below 85° C., and a melt index, measured in accordance with ASTM D 1238 at 190° C., ranging from 1, preferably 2 or 3, to 30 g/10 minutes, and especially from 2, preferably 3, to 15 g/10 minutes.

Ethylene/alkyl acrylate copolymers can be prepared by processes well known in the polymer art using either autoclave or tubular reactors. The copolymerization can be run as a continuous process in an autoclave: ethylene, the alkyl acrylate, and optionally a solvent such as methanol (see U.S. Pat. No. 5,028,674) are fed continuously into a stirred autoclave such as the type disclosed in U.S. Pat. No. 2,897,183, together with an initiator.

In a notable embodiment, the ethylene copolymer is of the type that is prepared in a tubular reactor, according to the procedure described in the article “High Flexibility EMA Made from High Pressure Tubular Process” (Annual Technical Conference—Society of Plastics Engineers (2002), 60^{th} (Vol. 2), 1832-1836).

The manufacturing of the tubular reactor ethylene/alkyl acrylate copolymers is preferably in a high pressure, tubular reactor at elevated temperature with additional introduction of reactant comonomer along the tube and not merely manufactured in a stirred high-temperature and high-pressure autoclave type reactor. However, it should be appreciated that similar ethylene/alkyl acrylate copolymeric material can be produced in a series of autoclave reactors wherein comonomer replacement is achieved by multiple zone introduction of reactant comonomer as taught in U.S. Pat. Nos. 3,350,372; 3,756,996; and 5,532,066, and as such these high melting point materials should be considered equivalent for purposes of this invention.

Suitable ethylene/alkyl acrylate copolymers include those available from DuPont.

When combined with other components of the adhesive composition, such as an anhydride-modified ethylene/alkyl acrylate copolymer, the total copolymerized residues of alkyl acrylate provides an amount of C(═O)O moieties. The weight % of C(═O)O moieties present in (a) and (b) can be correlated to the amount of copolymerized residues of alkyl acrylate present. For example, 7, 8, 9 or 15 weight % of C(═O)O moieties correspond to about 12.5, 14.3, 16 or 27 weight % of copolymerized residues of methyl acrylate or about 18.7, 21.3, 24 or 40 weight % of copolymerized residues of butyl acrylate respectively.

A mixture of two or more different ethylene/alkyl (meth)acrylate copolymers can be used in the blended compositions in place of a single copolymer as long as they provide for comonomer content (in particular the C(═O)O weight % of the combination of (a) and (b)) consistent with the ranges indicated above. Particularly useful properties may be obtained when two or more properly selected ethylene/alkyl (meth)acrylate copolymers are used.

Anhydride-Modified Ethylene Copolymers

The modified ethylene copolymers that can be used as component (b) in the adhesive composition comprise an ethylene copolymer having unsaturated dicarboxylic acid anhydride moieties, preferably derived from grafting from 0.1 to 3 weight % of anhydride moieties to ethylene/vinyl acetate copolymers or ethylene/alkyl acrylate copolymers. Monomers providing the unsaturated dicarboxylic acid anhydride moiety include maleic anhydride, citraconic anhydride, itaconic anhydride, tetrahydrophthalic anhydride, etc., with maleic anhydride being preferred. The anhydride provides a reactive functionality that promotes adhesion of the composition to the substrate to be protected. As noted above, the anhydride moiety should be present in from 0.03 to 2 weight % of the total adhesive composition.

In addition, the copolymerized residues of vinyl acetate or alkyl acrylate comonomers of the graft copolymers contain C(═O)O moieties that contribute to the overall polarity of the composition, similar to the nonmodified copolymers described above.

The modified ethylene copolymer can be obtained by known techniques, such as a process in which an ethylene/vinyl acetate copolymer or an ethylene/alkyl acrylate copolymer is dissolved in an organic solvent with an unsaturated dicarboxylic acid anhydride, such as maleic anhydride, and a radical generator, followed by heating with stirring; and a process in which all the components are fed to an extruder to provide a maleic-anhydride grafted ethylene copolymer.

Ethylene/vinyl acetate copolymers suitable for use in the anhydride-grafting processes are similar to those described above. The relative amount of the vinyl acetate comonomer incorporated into the copolymers can, in principle, vary broadly from about 7 weight percent up to as high as 45 weight percent of the total copolymer or even higher, prior to the grafting process. When an EVA copolymer is used as component (a), it is preferable to use an anhydride modified EVA copolymer as component (b). It may be further desirable to use an EVA copolymer with properties similar to those used in component (a) for modification with the unsaturated dicarboxylic acid anhydride to prepare component (b). Of note are EVA copolymers having from about 20 to about 40 weight %, especially from 25 to 28% by weight, of vinyl acetate modified with maleic anhydride at greater than one weight %.

Ethylene/alkyl acrylate copolymers suitable for use in the anhydride-grafting processes are similar to those described above. When an ethylene/alkyl acrylate copolymer is used as component (a), it is preferable to use an anhydride modified ethylene/alkyl acrylate copolymer as component (b). It may be further desirable to use an ethylene/alkyl acrylate copolymer with properties similar to those used in component (a) for modification with the unsaturated dicarboxylic acid anhydride to prepare component (b). Of note are EMA copolymers having from about 20 to about 40 weight %, especially from 20 to 25% by weight, of methyl acrylate modified with maleic anhydride at greater than one weight %.

These graft copolymers are available commercially from DuPont.

### Tackifying Agents

Tackifiers are used primarily to enhance initial adhesion to differentiated substrates. Tack is useful in a heat activated adhesive composition to allow for proper joining of articles before the heated adhesive hardens. Tackifiers are added to give tack to the adhesive and also to lower viscosity. The tackifier allows the composition to be more adhesive by improving wetting during the application. The presence of tackifiers lowers the resistance to deformation and hence facilitates bond formation on contact.

The tackifier may be any suitable tackifier known generally in the art such as those listed in U.S. Pat. No. 3,484,405. Such tackifiers include a variety of natural and synthetic resins and rosin materials. The resins that can be employed are liquid, semi-solid to solid, complex amorphous materials generally in the form of mixtures of organic compounds having no definite melting point and no tendency to crystallize. Such resins are insoluble in water and can be of vegetable or animal origin, or can be synthetic resins. The resins can provide substantial and improved tackiness to the composition. Suitable tackifiers include but are not necessarily limited to the resins discussed below.

A class of tackifiers is the coumarone-indene resins, such as the para-coumarone-indene resins. Generally the coumarone-indene resins that can be employed have a molecular weight that ranges from about 500 to about 5,000. Another class of tackifiers is the terpene resins, including also styrenated terpenes. These terpene resins can have a molecular weight range from about 600 to 6,000.

Other tackifiers are butadiene-styrene resins having a molecular weight ranging from about 500 to about 5,000. Polybutadiene resins having a molecular weight ranging from about 500 to about 5,000 are also useful as tackifiers. These materials are commercially available under the tradename BUTON.

A fifth class of resins that can be employed as the tackifier are the so-called hydrocarbon resins produced by catalytic polymerization of selected fractions obtained in the refining of petroleum, and having a molecular weight range of about 500 to about 5,000. Examples of such resin are those marketed as PICCOPALE-100, and as AMOCO and VELSICOL resins. Similarly, polybutenes obtained from the polymerization of isobutylene may be included as a tackifier. Hydrogenated hydrocarbon resins such as those available under the REGALITE tradename from Eastman Chemical Company are also suitable.

The tackifier may also include rosin materials, low molecular weight styrene hard resins or disproportionated pentaerythritol esters.

Rosins useful as tackifiers may be any standard material of commerce known as “rosin”, or a feedstock containing rosin. Rosin is mainly a mixture of C₂₀, tricyclic fused-ring, monocarboxylic acids, typified by pimaric and abietic acids, which are commonly referred to as “resin acids.” In the context of this invention, the term “rosin” collectively includes natural rosins, liquid rosins, modified rosins and the purified rosin acids, and derivatives of rosin acids, including partially to completely neutralized salts with metal ions, e.g. resinate, etc. The rosin material may be modified rosin such as dimerized rosin, hydrogenated rosin, disproportionated rosin, or esters of rosin. Essentially any reaction conditions recognized in the art for preparing modified rosin resins (including derivatives thereof) may be employed. Reaction products of rosins and their methods of preparation are well known in the art (see for example U.S. Pat. No. 2,007,983).

Aromatic tackifiers include thermoplastic hydrocarbon resins derived from styrene, alpha-methylstyrene, and/or vinyltoluene, and polymers, copolymers and terpolymers thereof, terpenes, terpene phenolics, modified terpenes, and combinations thereof.

Of note is the peelable surface protecting film wherein the at least one tackifier is a hydrocarbon tackifier.

A more comprehensive listing of tackifiers that can be employed is provided in the TAPPI CA Report #55, February 1975, pages 13-20, inclusive, a publication of the Technical Association of the Pulp and Paper Industry, Atlanta, Ga., which lists well over 200 tackifier resins that are commercially available.

Preferably, the peelable surface protecting film comprises an adhesive composition comprising or consisting essentially of at least 40 weight % of (a); the anhydride moiety is maleic anhydride present in from 0.05 to 1 weight % of the total of (a), (b) and (c); and from 4 to 20 weight % of tackifier.

Preferably, the adhesive composition comprises or consists essentially of at least 50 weight % of a copolymer comprising copolymerized residues of ethylene and copolymerized residues of vinyl acetate; from 10 to 25 weight % of a copolymer comprising copolymerized residues of ethylene and copolymerized residues of vinyl acetate, grafted with maleic anhydride; wherein the total C(═O)O moieties of (a) and (b) are present in from 9 to 15 weight % of the combination of (a) and (b) and the maleic anhydride moiety is present in from 0.2 to 1 weight % of the total of (a), (b) and (c).

Preferably, the adhesive composition comprises or consists essentially of at least 50 weight % of a copolymer comprising copolymerized residues of ethylene and copolymerized residues of methyl acrylate; from 10 to 25 weight % of a copolymer of ethylene and copolymerized residues of methyl acrylate, grafted with maleic anhydride; wherein the total C(═O)O moieties of (a) and (b) are present in from 8 to 15 weight % of the combination of (a) and (b) and the maleic anhydride moiety is present in from 0.3 to 1 weight % of the total of (a), (b) and (c); and from 7 to 20 weight % of tackifier.

The adhesive compositions or the compositions used to prepare the structure layer can comprise additional optional materials, such as additives commonly used in polymeric materials including plasticizers, ultraviolet (UV) ray absorbers, stabilizers including viscosity stabilizers, UV stabilizers and hydrolytic stabilizers, antioxidants, anti-static agents, dyes, pigments or other coloring agents including for example titanium dioxide or carbon black, fire-retardants, lubricants, foaming or blowing agents, processing aids, antiblock agents, release agents, and/or mixtures thereof. These additives may be present in the compositions in quantities that are generally from 0.01 to 15 weight %, alternatively from 0.01 to 10 weight % or from 0.01 to 5 weight %, so long as they do not detract from the basic and novel characteristics, in particular the adhesive characteristics, of the composition.

The optional incorporation of such ingredients into the compositions can be carried out by any known process. This incorporation can be carried out, for example, by dry blending, by extruding a mixture of the various constituents, by a masterbatch technique, or the like. Of note is a masterbatch comprising at least one thermoplastic resin and either titanium dioxide or carbon black that can be used to prepare the structure layer(s).

The components used in the compositions can be dry blended and subsequently melt blended in a twin-screw extruder and repelletized as is known in the art, or processed directly into the multilayer film structure. For example, the blends can be prepared by melt mixing the components in a 30-mm twin-screw extruder, using a melt temperature of from 180° C. to 230° C.

The melt index of the blended compositions can range from about 1, preferably 2, to about 20 g/10 minutes. For good film processability, especially in blown film processing, the MI is desirably below about 15, preferably below about 10 g/10 minutes.

The method for manufacturing the peelable surface protecting film is not particularly limited. The compositions described above can be converted and applied by a variety of techniques and processes. For example, the adhesive composition can be converted into a film by cast or blown film die extrusion techniques and laminated to another film that provides the structure layer of the multilayer film structure. As an alternative, the adhesive composition can be coextruded with other thermoplastic polymers using cast film or blown film techniques to provide a multilayer film. In other applications, the adhesive composition can be directly coated onto a film substrate in processes well known in the art, including, for example, extrusion coating and coextrusion coating. The thickness of the film is from 10 to 500μ, preferably from 20 to 300μ. Depending on the use, the thickness of the individual layers could vary. For example, the at least one structure layer of component (1) can be from 45 to 65μ thick and the adhesive layer of component (2) can be about 15μ thick. When more than one structure layer is used, the individual structure layers can be from 10 to 40μ thick.

An embodiment of note is a three-layer film comprising a first structure layer having a white pigment such as titanium dioxide, a second structure layer having a black pigment such as carbon black, and a third layer that is an adhesive layer, wherein one face of the second structure layer is adhered directly to the first structure layer and the opposite face is adhered directly to the adhesive layer. In this embodiment, the first structure layer is primarily used to accept printing and provides the outer surface of the film after adherence to a substrate, the second structure layer provides UV stabilization, and the adhesive layer provides controlled adhesion to the substrate surface.

Preferably, an example of this embodiment is a coextruded film, particularly one in which the structure layers are prepared from mixtures of low density polyethylene and linear low density polyethylene. Coextrusion is desirable because it allows for strong adhesion of the adhesive layer to the structure layer.

A peelable surface protecting film obtained as described above is subjected to a thermal lamination to the surface of metal plates such as color coated steel plates, stainless steel plates, aluminum plates, and copper plates, so that the adhesive layer is adhered to the metal plate and the structure layer forms the outside surface to protect the plate from damage, peeling of coating, contamination, corrosion, etc., during transport, storage, or molding. The lamination may be carried out in a temperature range from about 40 to about 60° C., preferably from about 50 to about 60° C., by using a roll, press, etc. Application at higher temperatures may be contemplated, but may result in higher peel strengths.

Alternatively, the adhesive composition may be applied as a molten curtain between the substrate and a film that provides the structure layer by well known extrusion lamination techniques. The protective structure also may be applied to the surface of a metal plate by extrusion lamination wherein the adhesive composition and the structure layer composition(s) are coextruded.

In some instances, the protective multilayer film structure can be applied to a surface of a substrate to be protected as part of a continuous manufacturing process. In a continuous process, the substrate may be warm enough from a prior manufacturing step to provide the heat needed to effect adhesion of the film. In other cases, the surface of the substrate and/or the protective film is heated and the film adhered to the substrate in a separate operation. For example, the film may be applied to a substrate using a heated nip roll.

When applied to a plate as described above with the adhesive layer adhered to the surface of the metal and covered by the at least one structure layer, there is no blocking characteristic of the film, so the metal plates do not stick to each other on stacking or during other manipulations. As indicated above, low-temperature application is possible, and the secondary workability such as bendability or drawability in a state in which the film is applied to the metal plate surface is also excellent. Thus, the film can be effectively used as a surface protecting material of various kinds of metal plates and molded products.

The film is mainly used as a protective film for metal plates. However the film can also be useful as a protective film of synthetic resin plates in which for example, methacrylic resin, polycarbonate resin, and the like are used as materials. The adhesion provided may also allow the film to be used to protect treated wood, wood composite, glass and paper surfaces.

The protective film may be applied to one major surface of a substrate (e.g. a plate or panel), or a film may be applied to each of the major surfaces of a plate or panel so that both surfaces of the plate or panel are protected.

A particularly notable article that can be protected by the film is a plate that serves as the outer skin of a building panel, and one or both surfaces of the panel itself.

Recent changes in the construction industry have led to an increased use by builders of premanufactured or fabricated construction components. Premanufactured building panels are used for walls, roofs, floors, doors, and other components of a building. Premanufactured building components are desirable because they can be designed and fabricated to factory-controlled specifications. In addition, premanufactured components are readily transportable, efficiently packaged, and easily handled. Premanufactured components for building construction have a variety of constructions. A common component is a laminated or composite panel. Often, such panels have features that allow rapid assembly into building structures. Use of such building panels can decrease the time and expense involved in constructing new building structures. Insulated building panels for modular construction of walls, ceilings, or the like are well known in the art.

The general structure of a building panel comprises a first outer sheet and a second outer sheet separated by an interior core. The core is preferably constructed of any suitable insulating material. Such materials include polyethylene, expanded polystyrene, urethane, polyisocyanate, or the like. The core is suitably preformed or foamed-in-place material as is known in the art. The core is generally rectangular in shape, having two opposite major surfaces to which the outer sheets are attached and two opposite reduced thickness side surfaces. The two side surfaces are generally perpendicular to the major surfaces. Preferably, the distance between the side surfaces (the width of the major surfaces) is less than the length of major surfaces. One such composite panel includes a core material of foam or other insulating material positioned between wood members, and the combination is fixed together by nails, screws, or adhesives.

Laminate panels can also be formed of two thin, outer (or skin) sheets and an internal, relatively thick insulating core. These panels address many of the disadvantages of wood laminate panels. The outer sheets are thin and preferably made from a flexible metal, which is suitably aluminum, steel, or other metals as are known in the art. Alternatively, sheets are formed from a plastic or resin material; such materials are known in the art. Sheets may also be formed of wood, wood composite, masonite, hardboard, medium density fiberboard, fiber-reinforced plastics, or cementboard. Both sheets are shaped to conform with and be attached to core. The sheets are attached to the core by a suitable adhesive as is also known in the art. The thickness of the sheets is generally small compared to the thickness of the core (the distance between the attached sheets). Preferably, the sheets have a thickness between 0.01 and 0.15 inches depending on the material used, and the core may be up to several inches thick.

Building panels can be manufactured with a decorative and/or finish surface already applied. This allows for the reduction or elimination of post-construction finish work such as, for example, painting, wallpapering and texturing. Finishes may also be applied under controlled conditions not possible at a construction site. However, finished surfaces are vulnerable to damage caused by scraping, scuffing, scratching and the like during transportation and assembly of the building panels. Therefore, it is desirable to protect such finished surfaces until construction is complete. Films as described herein can be used to protect the finished surface.

The panels may be provided with a finish surface by treatments such as polishing, texturizing, coating, painting, application of anticorrosion agents and the like. The finish may be used to simulate expensive building surfaces such as decorative woods, granite, marble and other polished stone surfaces. The most prevalent simulation technique includes laminating a representation of the surface to be simulated. Representations of lettering, logos and crests may also be applied. Laminating essentially involves attaching a sheet having the simulated image to the panel. A polymeric coating can be applied over the surface carrying the image to protect the image.

For example, a high-resolution image can be transferred to a coated substrate using sublimation printing techniques. High-resolution, digital images are taken of a natural surface. These images are used to create an image on a transfer paper using sublimation inks. Building panels are provided with a polyester epoxy acrylate coating, or equivalent substrate capable of receiving sublimable inks. The transfer paper with the printed image is placed face-down on the substrate of the building panel. The transfer paper is pressed against the substrate and heated for a time sufficient to gasify the sublimable inks. The gasification causes the image to transfer into the image-receiving substrate. Further, the image-receiving substrate may provide various sheens, as desired. Such techniques are described in more detail in U.S. Pat. No. 6,686,315.

Alternatively, the building panel may have a designed or textured surface including concave and convex portions to simulate other surfaces such as natural materials. For example, the concave and convex portions have an uneven surface and are colored such that the panel has the appearance of the surface of a rock. One method for coloring the surface consists of forming a dot-coating layer on the designed surface. The method includes the steps of transferring a dot-presenting paint onto the designed surface for forming a plurality of dots via a transfer roll, the transfer roll having a plurality of protruding portions on a roll surface in order to form the dot-coating layer, wherein the plurality of dots are formed so that areas of the dots are varied through differences in pressurizing force applied by the protruding portions onto the designed surface. Each coated dot comprises a dot formed of dot-presenting paint that is transferred on the designed surface of the building panel through a single protruding portion on the transfer roll. Additional undercoat, intermediate and overcoat layers of paint may be applied to achieve a realistic three-dimensional effect. Such techniques are described in more detail in U.S. Pat. No. 6,444,266.

Other surfaces that may be protected by the peelable surface protecting film include surfaces of body panels and other parts of vehicles, appliances, furniture, cabinets, glazing and the like.

Once the need for protection of the substrate is complete, the film can be peeled cleanly from the substrate.

The following Examples are presented to more fully demonstrate and illustrate various aspects and features of the present invention. As such, they are intended to further illustrate the differences and advantages of the present invention, but are not meant to be unduly limiting.

### EXAMPLES

Adhesive compositions were prepared by melt compounding in a 25-mm Berstorff twin screw extruder. Extruder screws were built to allow for melting/kneading and proper dispersions of all the components. The zone temperatures were set at 130° C. to 190° C. with a melt temperature of from 205 to 210° C. A screw speed of 250 rpm was used for all the compositions. The feed rate was set at 6 kg/hr. The compositions were all then dried in an oven at 40° C. for 8 to 12 hours to remove any excess water.

Materials Used

EVA-1: Ethylene/vinyl acetate copolymer having 25 weight % VA, with MI of 2.0 g/10 minutes and a melting point of about 77° C.

EVA-2: Ethylene/vinyl acetate copolymer having 24 weight % VA, with MI of 2.5 g/10 minutes and a melting point of about 78° C.

EVA-3: Ethylene/vinyl acetate copolymer having 28 weight % VA, with MI of 6.0 g/10 minutes and a melting point of about 69° C.

EVA-4: Ethylene/vinyl acetate copolymer having 28 weight % VA, with MI of 2.0 g/10 minutes and a melting point of about 73° C.

EVA-5: Ethylene/vinyl acetate copolymer having 18 weight % VA, with MI of 2.5 g/10 minutes and a melting point of about 87° C.

EVA-6: Ethylene/vinyl acetate copolymer having 18 weight % VA, with MI of 8 g/10 minutes and a melting point of about 86° C.

EVA-7: Ethylene/vinyl acetate copolymer having 15 weight % VA, with MI of 2.5 g/10 minutes and a melting point of about 92° C.

EMA-1: Ethylene/methyl acrylate copolymer having 9 weight % MA, with MI of 2.0 g/10 minutes.

EMA-2: Ethylene/methyl acrylate copolymer having 24 weight % MA, with MI of 2.0 g/10 minutes.

EMA-3: Ethylene/methyl acrylate copolymer having 20 weight % MA, with MI of 8.0 g/10 minutes.

EBA-1: Ethylene/butyl acrylate copolymer having 27 weight % BA, with MI of 4.0 g/10 minutes.

Graft-1: Ethylene/vinyl acetate copolymer having 28 weight % VA grafted with 1.45 weight % maleic anhydride, with MI of 1.4 g/10 minutes.

Graft-2: Polypropylene random copolymer grafted with 1.4 weight % maleic anhydride, with calculated MI of 450 g/10 minutes.

Graft-3: Ethylene/methyl acrylate copolymer having 24 weight % MA grafted with 1.8 weight % maleic anhydride, with MI of 1.8 g/10 minutes.

Tack-1: Hydrogenated hydrocarbon resin tackifier, available from Eastman Chemical Company under the tradename REGALITE®1125.

PE-1: polyethylene with density 0.902, MI of 3.

Antiblock-1: a saturated fatty primary monoamide used for its antiblock properties, supplied under the trade name Kemamide® by Chemtura.

Antioxidant-1: Tetrakismethylene (3,5-di-t-butyl-4-hydroxyhyrocin nomate) methane [CAS 6683-19-8] sold under trade name AnOX™ 20N from Chemtura.

The adhesive compositions are summarized in Tables 1 and 2, where the entries indicate weight % of the ingredients. In Tables 1 and 2, all compositions contain 0.1 weight % of Antioxidant-1 in addition to the materials listed. Compositions that contained PE-1 contained 0.3 weight % Antiblock-1, while compositions without PE-1 contained 0.5 weight % Antiblock-1.

These compositions form the adhesive layers of films as described below.

TABLE 1

| Ex. | EVA-1 | EVA-2 | EVA-3 | EVA-4 | EVA-5 | EVA-6 | EVA-7 | | Tack-1 | PE-1 |
|---|---|---|---|---|---|---|---|---|---|---|
| | | | | | | | | Graft-1 | | |
| C1 | 100 | 0 | 0 | 0 | 0 | 0 | 0 | 0 | 0 | 0 |
| C2 | 0 | 0 | 100 | 0 | 0 | 0 | 0 | 0 | 0 | 0 |
| 3 | 34.7 | 34.7 | 0 | 0 | 0 | 0 | 0 | 20 | 10 | 0 |
| 4 | 0 | 0 | 37.2 | 37.2 | 0 | 0 | 0 | 5 | 20 | 0 |
| 5 | 0 | 0 | 35.95 | 35.95 | 0 | 0 | 0 | 12.5 | 15 | 0 |
| 6 | 0 | 0 | 29.7 | 29.7 | 0 | 0 | 0 | 20 | 20 | 0 |
| 7 | 0 | 0 | 34.7 | 34.7 | 0 | 0 | 0 | 20 | 10 | 0 |
| 8 | 0 | 29.7 | 29.7 | 0 | 0 | 0 | 0 | 20 | 20 | 0 |
| 9 | 0 | 0 | 11.88 | 47.52 | 0 | 0 | 0 | 20 | 20 | 0 |
| 10 | 60.9 | 0 | 0 | 0 | 0 | 0 | 0 | 20 | 15 | 3.75 |
| 11 | 57.1 | 0 | 0 | 0 | 0 | 0 | 0 | 30 | 10 | 2.5 |
| 12 | 41.1 | 0 | 32.3 | 0 | 0 | 0 | 0 | 20 | 5 | 1.25 |
| 13 | 16.88 | 0 | 0 | 67.52 | 0 | 0 | 0 | 5 | 10 | 0 |
| 14 | 0 | 42.2 | 42.2 | 0 | 0 | 0 | 0 | 5 | 10 | 0 |
| 15 | 22.3 | 0 | 0 | 0 | 22.3 | 0 | 0 | 30 | 20 | 5 |
| 16 | 67.1 | 0 | 0 | 0 | 0 | 0 | 0 | 20 | 10 | 2.5 |
| 17 | 35.95 | 35.95 | 0 | 0 | 0 | 0 | 0 | 12.5 | 15 | 0 |
| 18 | 42.2 | 42.2 | 0 | 0 | 0 | 0 | 0 | 5 | 10 | 0 |
| 19 | 37.2 | 37.2 | 0 | 0 | 0 | 0 | 0 | 5 | 20 | 0 |
| 20 | 0 | 0 | 34.7 | 34.7 | 0 | 0 | 0 | 20 | 10 | 0 |
| C21 | 37.3 | 0 | 0 | 0 | 0 | 37.3 | 0 | 25 | 0 | 0 |
| C22 | 0 | 0 | 0 | 0 | 0 | 0 | 27.1 | 35 | 30 | 7.5 |
| | | | | | | | | Graft-2 | | |
| C23 | 60.9 | 0 | 0 | 0 | 0 | 0 | 0 | 20 | 15 | 3.75 |

TABLE 2

| Ex- | | | | | | | |
|---|---|---|---|---|---|---|---|
| ample | EMA-1 | EMA-2 | EMA-3 | EBA-1 | Graft-3 | Tack-1 | PE-1 |
| C25 | 100 | 0 | 0 | 0 | 0 | 0 | 0 |
| C26 | 0 | 0 | 0 | 100 | 0 | 0 | 0 |
| C27 | 59.6 | 0 | 0 | 0 | 20 | 16 | 4 |
| 28 | 0 | 69.6 | 0 | 0 | 20 | 8 | 2 |
| 29 | 0 | 59.6 | 0 | 0 | 20 | 16 | 4 |
| 30 | 0 | 84.6 | 0 | 0 | 5 | 8 | 2 |
| 31 | 0 | 77.1 | 0 | 0 | 12.5 | 8 | 2 |
| 32 | 0 | 0 | 69.6 | 0 | 20 | 8 | 2 |
| 33 | 0 | 0 | 59.6 | 0 | 20 | 16 | 4 |
| 34 | 0 | 0 | 0 | 69.6 | 20 | 8 | 2 |
| 35 | 0 | 0 | 0 | 59.6 | 20 | 16 | 4 |

The adhesive compositions were cast into 3-layer films with a LLDPE having MI of 4.8 g/10 min (SCLAIR 8107, sourced from Nova Chemicals) as backing layers. The film was prepared using a co-extrusion consisting of NRM Extruder (1.75 inch), Killion Extruder (1 inch), Wayne Extruder (1.25 inch) and a Wayne Casting unit. The temperature zones were set at 130 to 200° C. Screw speeds were adjusted based on the desired output at 8.2, 18.9 and 13.0 rpm respectively. The casting speed was set at 25 to 27 feet/minute. The resulting films had the following structure, with thickness in parentheses:

LLDPE (32μ)/LLDPE (13μ)/adhesive layer (15μ); (total of 60μ).

The films as described above were adhered to 4-inch painted building panel surfaces using a Glenro Flat Bed Laminator. The zone temperatures were set at 70° C. so the surface temperature was about 55° C. with a nip roll pressure of 50 psi. The line speed was set at 0.5 m/minute. At least three sample panels from each composition were made in random order. When more than three samples using a composition were prepared, they were prepared and tested in groups of three and the aggregate results for all samples using that composition are reported in Table 3 and 4.

Sample panels were conditioned at 23° C. and 50% relative humidity for at least 24 hours prior to peel testing. The films were peeled using an Instron peel tester. Cross-head speed was set at 6 inches/minute with 180° peel angle. The green peel strengths were recorded in the plateau region. Average peel strength and standard deviation were calculated for the samples and are summarized in Tables 3 and 4. All samples peeled cleanly, with no adhesive residue left on the panel surface. Three sample panels were prepared using a commercial pressure-sensitive adhesive (PSA) film used as a protective film for building panels, available from HaiNing RiXing. This PSA film was peel tested in the same manner (Comparative Example C24).

In these tables “% C(═O)O” shows the weight % of the combined C(═O)O calculated from the copolymer(s) used in (a) and (b), “% MAH” is the weight % of maleic anhydride of the total composition and “MI” is the melt index of the composition.

TABLE 3

| | | | | | Standard |
|---|---|---|---|---|---|
| | | | | T-Peel Strength | deviation |
| Example | % C(═O)O | % MAH | MI | (g/inch) | (g/inch) |
| C1 | 12.8 | 0 | 2.0 | 0 | 0 |
| C2 | 14.3 | 0 | 6.0 | 26.2 | 7.3 |
| 3 | 11.6 | 0.29 | 4.9 | 88.9 | 25.0 |
| 4 | 11.4 | 0.07 | 14.2 | 94.5 | 18.9 |
| 5 | 12.1 | 0.18 | 9.27 | 111.9 | 45.4 |
| 6 | 11.4 | 0.29 | 13.82 | 142.7 | 36.9 |
| 7 | 12.8 | 0.29 | 6.55 | 145.1 | 33.7 |
| 8 | 10.7 | 0.29 | 10.85 | 128.1 | 35 |
| 9 | 11.4 | 0.29 | 11.3 | 189 | 18.2 |
| 10 | 10.6 | 0.29 | 5.4 | 194.1 | 21.9 |
| 11 | 11.6 | 0.44 | 3.8 | 147.4 | 51.4 |
| 12 | 12.7 | 0.29 | 4.2 | 135.2 | 44.5 |
| 13 | 12.8 | 0.07 | 7.6 | 117.9 | 36.3 |
| 14 | 11.9 | 0.07 | 8.3 | 100.8 | 24.1 |
| 15 | 9.2 | 0.44 | 9.6 | 96.2 | 31.7 |
| 16 | 11.5 | 0.29 | 4.2 | 82.2 | 56.6 |
| 17 | 10.8 | 0.18 | 5.83 | 79.7 | 12.3 |
| 18 | 11.3 | 0.07 | 4.9 | 49.6 | 6.4 |
| 19 | 10 | 0.07 | 9.1 | 73.3 | 25.3 |
| 20 | 11.4 | 0.29 | 11.3 | 167.1 | 7 |
| C21 | 11.8 | 0.36 | 3.1 | 2.4 | 4.2 |
| C22 | 7.1 | 0.51 | 17.5 | 52.7 | 40 |
| C23 | 7.8 | 0.28 | 23.8 | 6.8 | 5.6 |
| C24 | NA | NA | NA | 126.4 | 24.6 |

The results for Comparative Examples C1 and C2 show that 100% ethylene/vinyl acetate copolymer compositions do not provide adhesion under these conditions. The result for Comparative Example C21 demonstrates the need for a tackifier in the composition to provide adequate adhesion. The result for Comparative Example C22 shows that a low amount of ethylene/vinyl acetate copolymer in the composition provides inadequate adhesion, even with high levels of anhydride graft copolymer and tackifier. The result for Comparative Example C23 shows that a composition comprising a polypropylene-based anhydride graft copolymer provides low adhesion when applied at temperatures between 40 and 60° C.

TABLE 4

| | | | | T-Peel | |
|---|---|---|---|---|---|
| | | | | Strength | Standard |
| Example | % C(═O)O | % MAH | MI | (g/inch) | deviation (g/inch) |
| C25 | 4.6 | 0 | 2.0 | 0 | 0 |
| C26 | 9.3 | 0 | 4.0 | 0 | 0 |
| C27 | 5.2 | 0.36 | 7.7 | 36.1 | 16.5 |
| 28 | 11.0 | 0.36 | 4.7 | 46.7 | 8.1 |
| 29 | 9.8 | 0.36 | 8.6 | 120.1 | 30.4 |
| 30 | 11.0 | 0.09 | 5.1 | 74.5 | 23.8 |
| 31 | 11.0 | 0.23 | 4.7 | 69.4 | 11.1 |
| 32 | 9.6 | 0.36 | 10.5 | 127.6 | 31.4 |
| 33 | 8.6 | 0.36 | 16.6 | 106.7 | 42 |
| 34 | 8.9 | 0.36 | 6.5 | 99.5 | 18.9 |
| 35 | 8.0 | 0.36 | 11.4 | 222.4 | 37 |

The results for Comparative Examples C25 and C26 show that 100% ethylene/alkyl acrylate copolymer compositions do not provide adhesion under these conditions. The result for Comparative Example C27 shows that a low amount of polar components, as indicated by the weight % of C(═O)O in the composition, provides inadequate adhesion, even with high levels of anhydride graft copolymer and tackifier.

The results for Examples 28, 30 and 31, when compared to the other Examples, also indicate that compositions having MI greater than about 6 provide better adhesion.

Oven-Aging Tests

Oven-aging tests were conducted to assess whether the adhesive characteristic of the protective films changed over time, in particular whether the peel strength increased to an unacceptable level (“age-up”). Multilayer protective films were made and applied to aluminum panels at a surface temperature of 55° C. as described previously. These panels then were laid flat in a convection oven set at 60° C. for up to 10 days. Individual panels were taken out of the oven after the indicated time and were conditioned and tested as described previously. The “aged” peel results for these two compositions (single replicates for each condition) are shown in Table 5.

TABLE 5

| | EVA Based Composition | EMA Based Composition |
|---|---|---|
| Example | 11 | 25 |
| Number of Days | Peel Strength (g/inch) | |
| 0 | 202.8 | 165.6 |
| 1 | 204.1 | 256.4 |
| 2 | 210.5 | 201.8 |
| 3 | 236.8 | 279.6 |
| 7 | 391.4 | 249.1 |
| 10 | 252.8 | 248.2 |

The results summarized in Table 5 indicate there is no appreciable “age-up” after 10 days exposure to 60° C. temperature.

Additional 3-layer films were prepared using blown film coextrusion methodology. The inner layer of the bubble consisted of a blend of linear low density polyethylene (about 45 weight %), low density polyethylene (about 53 weight %) and titanium dioxide (about 2 weight %) to provide a white layer; the middle layer of the bubble consisted of a blend of linear low density polyethylene (about 53.6 weight %), low density polyethylene (about 46.2 weight %) and carbon black (about 0.2 weight %) to provide a black layer; the outer layer of the bubble consisted of an adhesive composition as indicated in Table 3. To facilitate uniform dispersion, the white and black pigments were added to the respective compositions in masterbatches comprising LLDPE and LDPE. After quenching, the tubular films were slit to form flat films 1.26 m wide and about 50 to 60 meters in length and taken up on rolls.

When used as a protective film, the adhesive layer is adhered to the substrate and the white layer is the outside layer.

TABLE 6

| | Adhesive | Thickness (μ) | | |
|---|---|---|---|---|
| Example | Composition | Adhesive Layer | White Layer | Black Layer |
| 36 | Example 12 | 15 | 35 | 30 |
| 37 | Example 12 | 15 | 25 | 25 |
| 38 | Example 25 | 15 | 35 | 30 |
| 39 | Example 25 | 15 | 25 | 25 |

The films from Examples 37 and 39 were adhered to commercial building panels and tested by oven aging using conditions similar to those described previously. The results (three replicates for each condition) are summarized in Table 7. As with other example films, these films showed no appreciable age-up under these conditions.

TABLE 7

| | EVA Based | | EMA Based | |
|---|---|---|---|---|
| | Composition | | Composition | |
| Example | 37 | | 39 | |
| Days | Peel Strength | Standard Dev. | Peel Strength | Standard Dev. |
| 0 | 184.3 | 46.2 | 175.3 | 28.4 |
| 1 | 328.1 | 63.1 | 183.4 | 9.2 |
| 2 | 403.2 | 43.6 | 189.4 | 7.3 |
| 3 | 390.2 | 51.5 | 236.5 | 16.9 |
| 7 | 440.1 | 93.9 | 213.5 | 14.4 |
| 10 | 379.6 | 111.8 | 225.8 | 23.7 |

The foregoing disclosure of embodiments has been presented for purposes of illustration and description. It is not intended to be exhaustive or to limit the invention to the precise forms disclosed. Many variations and modifications of the embodiments described herein will be evident to one of ordinary skill in the art in light of the above disclosure.

What is claimed:

1. A peelable surface protecting film comprising:
(1) a thermoplastic resin structure layer; and
(2) a layer of a heat activated adhesive composition comprising
(a) a copolymer comprising copolymerized residues of ethylene and copolymerized residues of vinyl acetate or copolymerized residues of an alkyl acrylate, the alkyl group having from 1 to 4 carbon atoms;
(b) a copolymer comprising copolymerized residues of ethylene, copolymerized residues of vinyl acetate or copolymerized residues of an alkyl acrylate, the alkyl group having from 1 to 4 carbon atoms, and copolymerized residues of an unsaturated dicarboxylic anhydride moiety; and
(c) from 4 to 35 weight % of tackifier;
wherein the combination of (a) and (b) is from 65 to 96 weight % of the total of (a), (b) and (c), the total C(═O)O moieties of (a) and (b) are present in from 7 to 15 weight % of the combination of (a) and (b), and the anhydride moiety is present in from 0.03 to 2 weight % of the total of (a), (b) and (c).

2. The peelable surface protecting film of claim 1 wherein the adhesive composition comprises at least 40 weight % of (a); the anhydride moiety is maleic anhydride present in from 0.05 to 1 weight % of the total of (a), (b) and (c); and from 4 to 20 weight % of tackifier.

3. The peelable surface protecting film of claim 2 wherein the adhesive composition comprises at least 50 weight % of a copolymer comprising copolymerized residues of ethylene and copolymerized residues of vinyl acetate; from 10 to 25 weight % of a copolymer comprising copolymerized residues of ethylene and copolymerized residues of vinyl acetate, grafted with maleic anhydride; wherein the total C(═O)O moieties of (a) and (b) are present in from 9 to 15 weight % of the combination of (a) and (b) and the maleic anhydride moiety is present in from 0.2 to 1 weight % of the total of (a), (b) and (c).

4. The peelable surface protecting film of claim 2 wherein the adhesive composition comprises at least 50 weight % of a copolymer comprising copolymerized residues of ethylene and copolymerized residues of methyl acrylate; from 10 to 25 weight % of a copolymer comprising copolymerized residues of ethylene and copolymerized residues of methyl acrylate, grafted with maleic anhydride; wherein the total C(═O)O moieties of (a) and (b) are present in from 8 to 15 weight % of the combination of (a) and (b) and the maleic anhydride moiety is present in from 0.3 to 1 weight % of the total of (a), (b) and (c); and from 7 to 20 weight % of tackifier.

5. The peelable surface protecting film of claim 1 wherein the at least one tackifier is a hydrocarbon tackifier.

6. The peelable surface protecting film of claim 1 that is a coextruded film.

7. The peelable surface protecting film of claim 1 wherein the structure layer comprises polyethylene homopolymers or copolymers, polypropylene homopolymers or copolymers, polyester, polyamide, polyvinyl chloride, polycarbonate or mixtures thereof, and optionally an ultraviolet stabilizer.

8. The peelable surface protecting film of claim 7, wherein the at least one structure layer comprises low density polyethylene or a mixture of low density polyethylene and linear low density polyethylene.

9. An article comprising the peelable surface protecting film of claim 1 and a substrate, wherein the adhesive layer is peelably adhered to the substrate.

10. The article of claim 9 wherein the substrate is metal, plastic or resin material, wood, wood composite, masonite, hardboard, medium density fiberboard, fiber-reinforced plastics, cementboard or glass, optionally having at least one substrate surface-treatment layer selected from the group consisting of surface polishing, texturizing, coating, painting, laminating of an image and anticorrosion treatment intervening between the adhesive layer and the substrate.

11. The article of claim 9 wherein the substrate is a plate.

12. The article of claim 11 wherein the plate is selected from the group consisting of color-coated steel plates, stainless steel plates and aluminum plates.

13. The article of claim 9 wherein the substrate is a building panel.

14. The article of claim 9 wherein the substrate is a body panel of a vehicle, appliance, furniture, cabinet, or glazing.

15. An article wherein one face of an adhesive layer is peelably adhered to a substrate comprising metal, plastic or resin material, wood, wood composite, masonite, hardboard, medium density fiberboard, fiber-reinforced plastics, cementboard or glass, either directly or through at least one intervening substrate surface-treatment layer; and the other face of the adhesive layer is irreversibly adhered to a structure layer comprising a thermoplastic resin; wherein the adhesive layer comprises
a) a copolymer comprising copolymerized residues of ethylene and copolymerized residues of vinyl acetate or copolymerized residues of an alkyl acrylate, the alkyl group having from 1 to 4 carbon atoms;
(b) a copolymer comprising copolymerized residues of ethylene, copolymerized residues of vinyl acetate or copolymerized residues of an alkyl acrylate, the alkyl group having from 1 to 4 carbon atoms, and copolymerized residues of an unsaturated dicarboxylic anhydride moiety; and
(c) from 4 to 35 weight % of tackifier;
wherein the combination of (a) and (b) is from 65 to 96 weight % of the total of (a), (b) and (c), the total C(═O)O moieties of (a) and (b) are present in from 7 to 15 weight % of the combination of (a) and (b), and the maleic anhydride moiety is present in from 0.03 to 2 weight % of the total of (a), (b) and (c).

16. The article of claim 15 wherein the adhesive layer is peelably adhered directly to the substrate layer.

17. The article of claim 16 wherein the adhesive layer is peelably adhered to the substrate through at least one intervening substrate surface-treatment layer selected from the group consisting of surface polishing, texturizing, coating, painting, laminating of an image and anticorrosion treatment.

18. The article of claim 15 wherein the structure layer comprises polyethylene homopolymers or copolymers, polypropylene homopolymers or copolymers, polyester, polyamide, polyvinyl chloride, and polycarbonate or mixtures thereof, and optionally an ultraviolet stabilizer.

19. The article of claim 18 wherein the structure layer comprises linear low density polyethylene or a mixture of low density polyethylene and linear low density polyethylene.

20. The article of claim 15 wherein the face of the adhesive layer is peelably adhered to the substrate layer with a peel strength from about 80 to about 400 g/inch.

21. The article of claim 20 wherein the peel strength is from about 100 to about 250 g/inch.

22. A process comprising providing the article of claim 9 and peeling the surface protecting film from the substrate.
